(19) United States
(12) Patent Application Publication
(10) Pub. No.: US 2002/0133517 A1
(43) Pub. Date: Sep. 19, 2002

(54) Method and apparatus for processing of internet forms

(75) Inventors: Michael Pierre Carlson, Austin, TX (US); Christopher Scott Milite, Oxford, CT (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/810,032

(22) Filed: Mar. 15, 2001

(51) Int. Cl. G06F 15/00

(52) U.S. Cl. 707/513

(57) ABSTRACT

A method, apparatus, and computer implemented instructions for processing a form in a data processing system. A markup language form is received in which the markup language form includes first data input by a user and second data in a hidden field identifying how the data is to be processed. A process is identified to process the first data using the second data to form an identified process. The first data is processed using the identified process.

### BACKGROUND OF THE INVENTION

1. Technical Field:

The present invention relates generally to an improved data processing system and in particular to a method and apparatus for transferring data between clients and servers in a network data processing system. Still more particularly, the present invention provides a method and apparatus for processing Internet forms.

2. Description of Related Art:

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and businesses use the Web to purchase various goods and services. In offering goods and services, some companies offer goods and services solely on the Web while others use the Web to extend their reach.

With the growth of electronic or e-business, more and more Web pages contain forms, requiring users to enter information. Each of these forms require some process to obtain and process the information. This process may be, for example, a servlet or a practical extraction report language (perl) script. A servlet is a Java application that runs in a Web server or application server and provides server-side processing, typically to access a database or perform e-commerce processing. Perl is a language for creating Web server programs to perform tasks, such as automatically updating user accounts and newsgroup postings, processing removal requests, synchronizing databases and generating reports. Typically, every form requires a method for process to analyze the data and forward the data to a useful location because different forms employ different use of input names and final location of the form data. By having different methods or processes, large amounts of code are required for processing different types of forms.

Therefore, it would be advantageous to have an improved method, apparatus, and computer implemented instructions for processing forms.

### SUMMARY OF THE INVENTION

The present invention provides a method, apparatus, and computer implemented instructions for processing a form in a data processing system. A markup language form is received in which the markup language form includes first data input by a user and second data in a hidden field identifying how the data is to be processed. A process is identified to process the first data using the second data to form an identified process. The first data is processed using the identified process.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating data flow used in processing a form in accordance with a preferred embodiment of the present invention;

FIG. 5 is a diagram of an HTML form displayed in a Web browser in accordance with a preferred embodiment of the present invention;

FIG. 6 is code illustrating an HTML form in source format in accordance with a preferred embodiment of the present invention;

FIG. 7 is a table illustrating key words in accordance with a preferred embodiment of the present invention; and

FIG. 8 is a flowchart of a process used for processing a HTML form in accordance with a preferred embodiment of the present invention.

### DETAILED DESCRIPTION OF THE PREFERRED EMBODIMENT

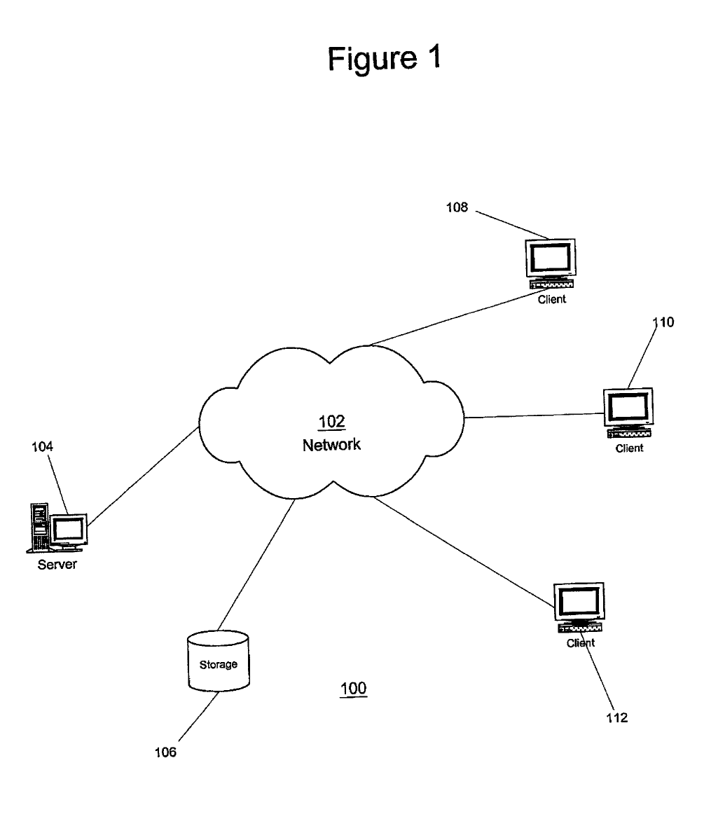

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

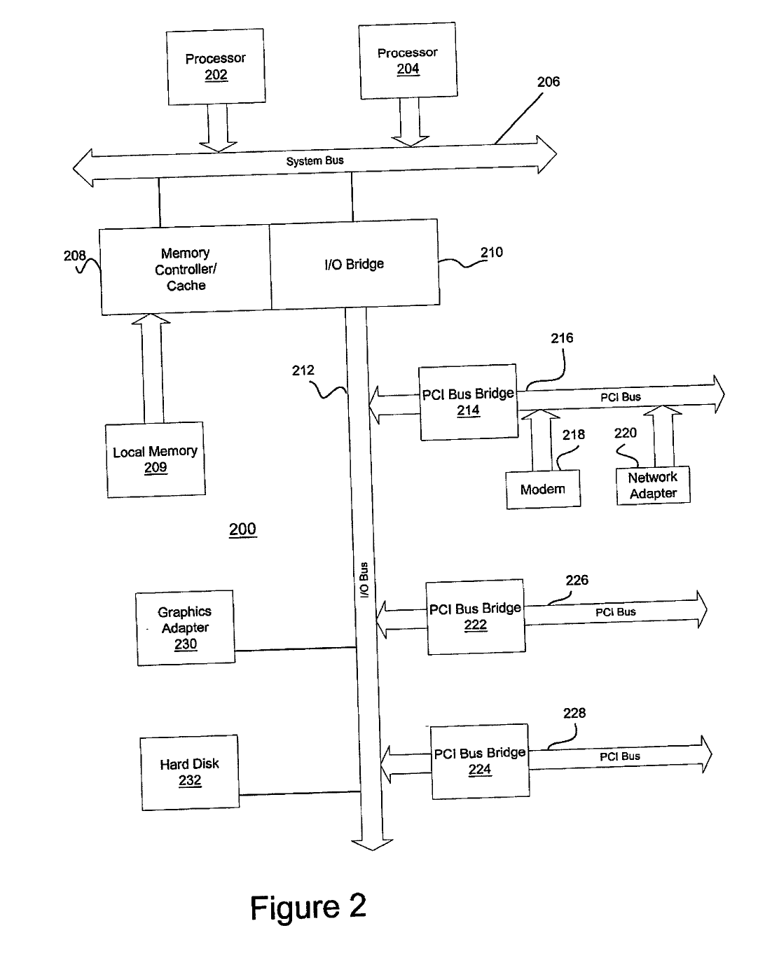

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

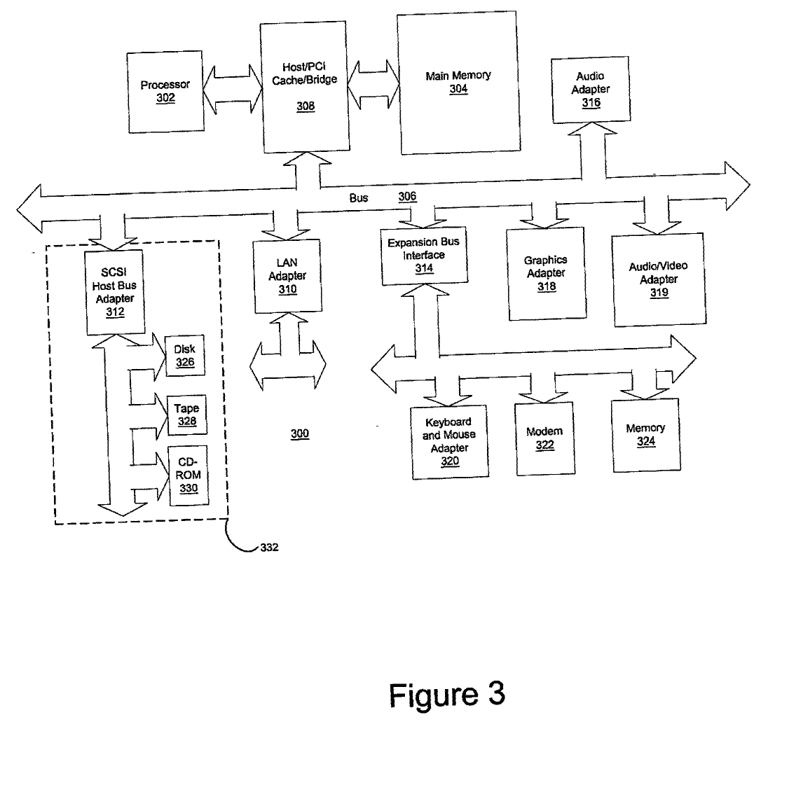

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer implemented instructions for handling electronic forms, such as those generated for Web sites. The mechanism of the present invention provides a generic form handler for checking input data for possible errors and to forward this data to the final location for use or storage. This forwarding of data may take various forms, such as, for example, generation of an e-mail message, placing data in a storage device, or other possible destinations. With the mechanism of the present invention, no additional code is required to handle the form. In essence, the mechanism of the present invention embeds processing instructions for the form within the document itself. In particular, information is included in the form, describing how the information should be handled, such as how the information is to be checked, processed, forwarded, and stored. In the depicted examples, the instructions are embedded within and HTML document using hidden inputs, such as the following: <INPUT type=“hidden”>.

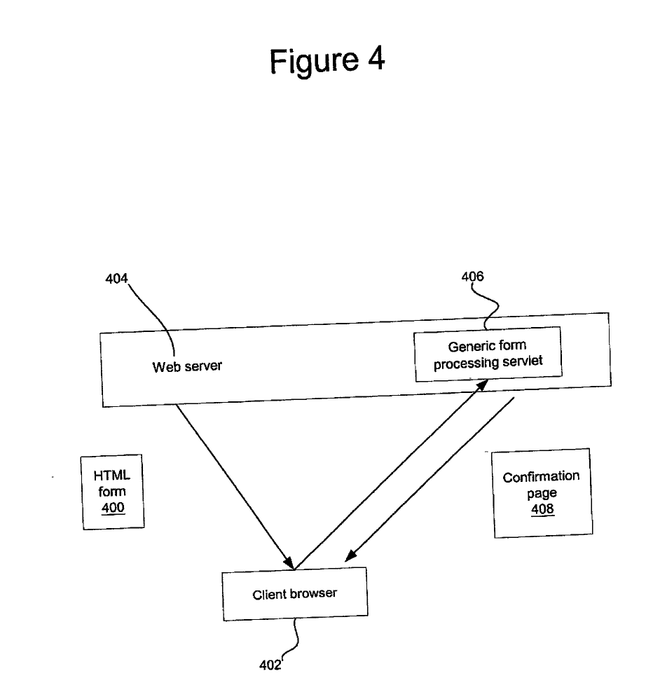

Turning next to FIG. 4, a diagram illustrating data flow used in processing a form is depicted in accordance with a preferred embodiment of the present invention. In this example, HTML form 400 is sent to browser client 402 from Web server 404. A user completes HTML form 400 in client browser 402 and submits this form to generic form processing servlet 406. In the depicted examples, the servlet is located in the same Web server as the form. Of course, generic form processing servlet 406 may be located on a different Web server or on an entirely different computer. Generic form processing server 406 uses hidden fields within HTML form 400 to verify, validate, and process the form. If all actions are successfully completed, confirmation page 408 is returned to the user at client browser 402. Otherwise, an error process may be initiated depending on the hidden fields within HTML form 400.

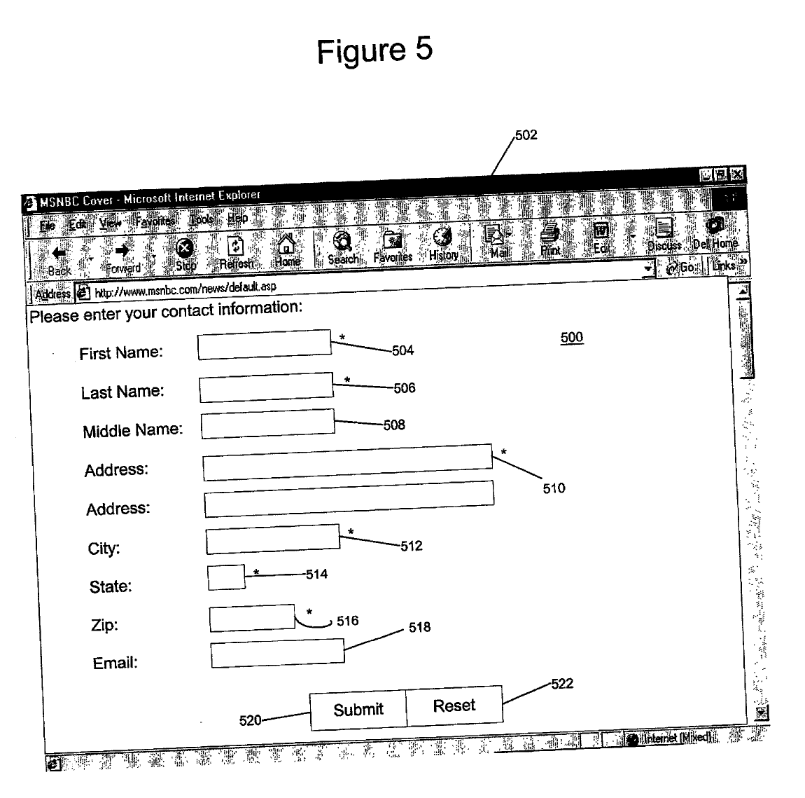

Turning next to FIG. 5, a diagram of an HTML form displayed in a Web browser is depicted in accordance with a preferred embodiment of the present invention. HTML form 500 is an example of an HTML document, such as HTML form 400 in FIG. 4 as displayed within Web browser 502. As can be seen, the fields first name 504, last name 506, middle name 508, address 510, city 512, state 514, zip code 516, and e-mail 518 are fields for a user to enter information. When the user has entered information, the user may select submit button 520 to send the form back to a servlet, such as generic form processing servlet 406 in FIG. 4. By selecting reset button 522, all of the fields within HTML form 500 are cleared. The form also includes hidden fields, which remain undisplayed to the user in Web browser 502. These fields are used to process the form when received by generic form processing servlet 406 in FIG. 4.

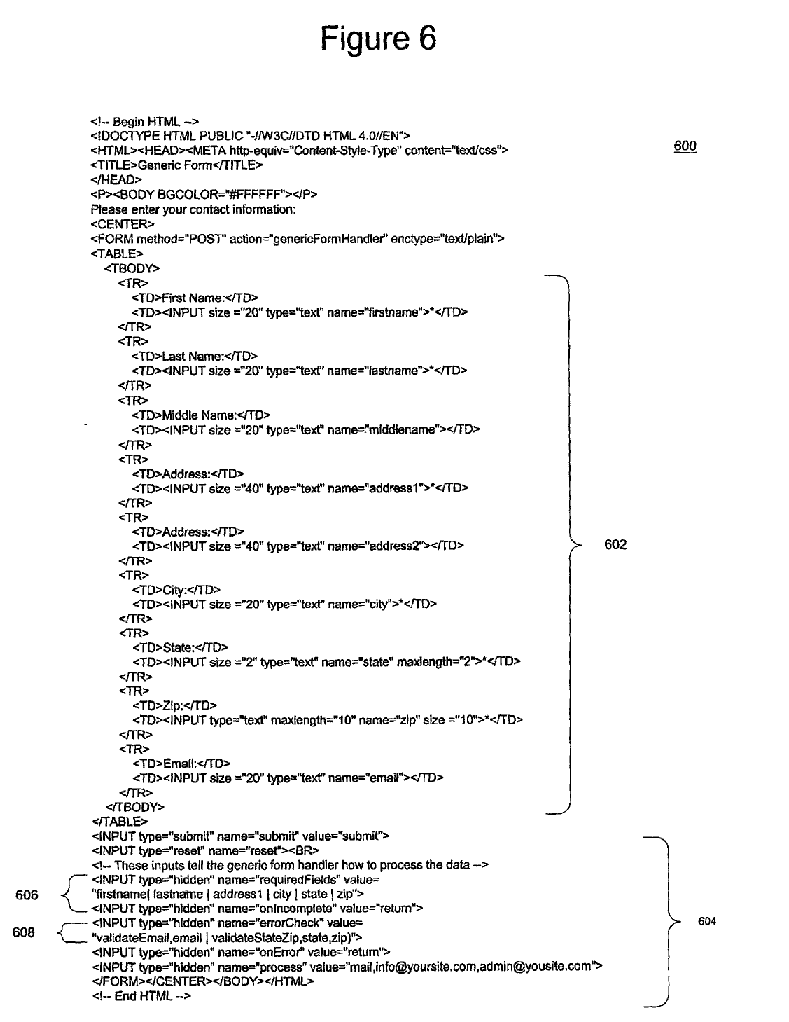

Turning next to FIG. 6, code illustrating an HTML form in source format is depicted in accordance with a preferred embodiment of the present invention. Code 600 in this example is HTML code for an HTML form, such as HTML form 500 in FIG. 5. As can be seen, section 602 contains information that is to be displayed to a user within a Web browser. Section 604 contains information as to how user input into the form is to be handled. For example, section 606 identifies required fields within the form. In the depicted examples, these required fields are first name, last name, address, city, state, and zip code. Next, section 608 indicates values that are to be validate, such as the e-mail address, state, and zip code.

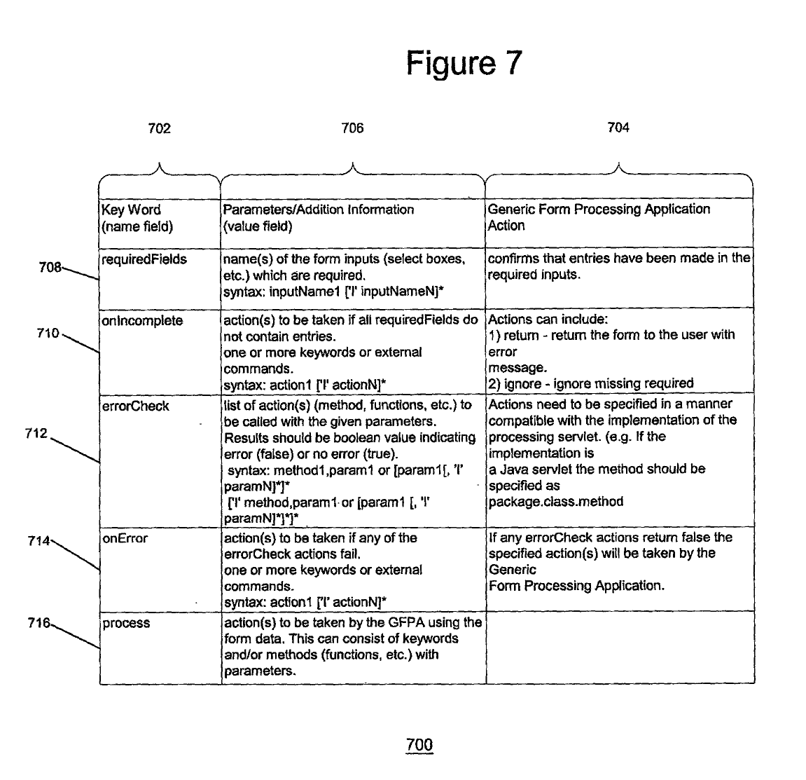

Each of these inputs include a key word used by generic form processing servlet 400 in FIG. 4 to process data. Turning next to FIG. 7, a table illustrating key words is depicted in accordance with a preferred embodiment of the present invention. Table 700 in this example includes key word column 702, which identifies key words that are recognized by the mechanism of the present invention. These key words are used as an index into table 700 to identify actions as shown in column 704. Column 706 identifies additional parameters or information that need to be passed to the process performing the action identified by the key word.

For example, the key word “requiredFields” in entry 708 is used to perform an action to confirm that entries have been made in the required input fields. In entry 710, the key word “onIncomplete” identifies actions that occur if all of the required fields do not contain entries. These actions are specified as a parameter in association with the key word. The key word “errorCheck” in entry 712 is used to specify actions to check for errors on parameters included with this key word. The particular actions are specified as a parameter in this example. In entry 714 the key word “onError” identifies actions to occur if an error check occurs. The key word “process” in entry 716 identifies actions to be taken using the data. Again the particular process is specified as a parameter to this key word. Although the depicted examples illustrate the information in a table form, this information may be placed in other data structures other than a table, such as a relational database.

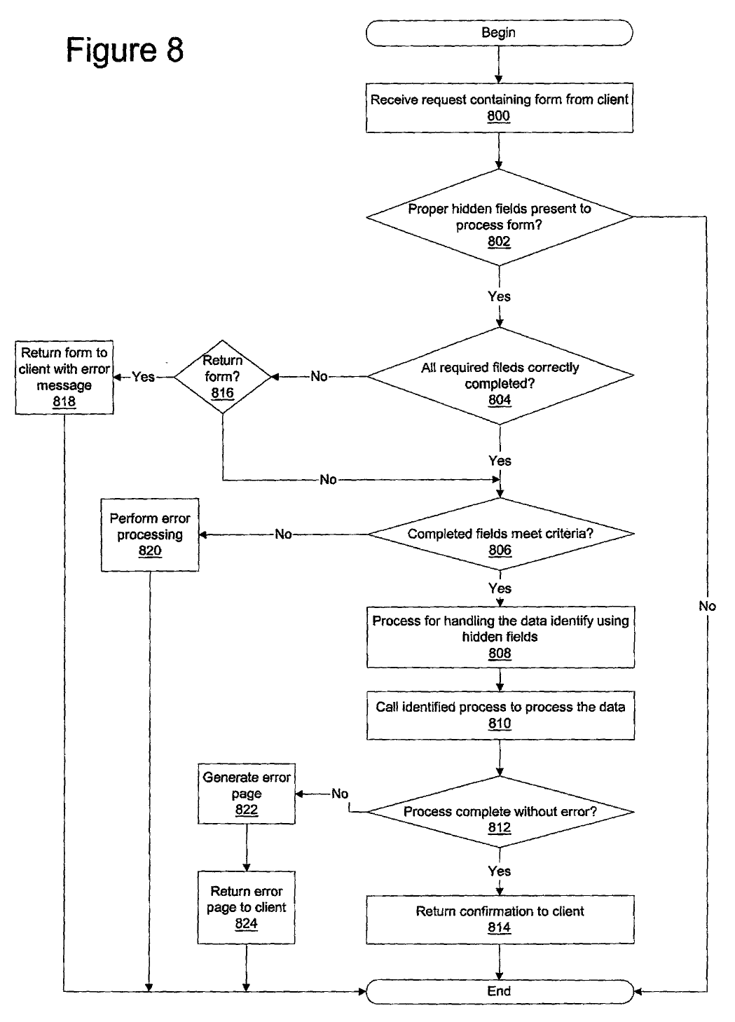

Turning next to FIG. 8, a flowchart of a process used for processing a HTML form is depicted in accordance with a preferred embodiment of the present invention. The process illustrated in FIG. 8 may be implemented in a servlet on a Web server, such as generic form processing servlet 406 in FIG. 4.

The process begins by receiving a request containing a form from a client (step 800). In the depicted examples, the form is an HTML form. A determination is made as to whether proper hidden fields are present to process the form (step 802). The proper hidden fields may be identified by determining whether key words are present within the hidden field. The key words may be identified by comparing information within these fields to a set of known or recognized key words.

If the proper hidden fields are present to process the form, a determination is made as to whether all required fields are correctly completed (step 804). If all required fields are correctly completed, a determination is made as to whether the completed fields meet criteria (step 806). This criteria may include, for example, checking to see whether the zip code field contains a valid zip code or whether a quantity in an order form contains a valid number.

If the completed fields meet the criteria, then a process for handling the data is identified using the hidden fields (step 808). This process may be, for example, sending an e-mail message, storing data, or triggering another process or method. Next, the identified process is called to process the data (step 810).

Thereafter, a determination is made as to whether the process is complete without error (step 812). If the process is complete without error, confirmation is returned to the client (step 814) with the process terminating thereafter.

With reference again to step 802, if the proper hidden fields are not present to process the form, the process terminates. Turning back to step 804, if all required fields are not correctly completed, a determination is made as to whether to return the form (step 816). If the form is not to be returned, the process returns to step 806. If the form is to be returned, the form is returned to the client with an error message (step 818) with the process terminating thereafter. An error message may request a user to reenter information into the form. This error message also may include an indication as to which fields were incorrectly entered.

With reference again to step 806, if the completed fields do not meet criteria, error processing is performed (step 820) with the process terminating thereafter. Error processing may include, but is not limited to returning the form with an error message as specified in the “onError” hidden field, such as shown in entry 714 in FIG. 7 to inform the user of the error and/or what is required to correctly complete the field. Another possible action includes continuing processing of the form and informing a server administrator of the error in the data.

With reference again to step 812, if the process is completed with an error occurring, an error page is generated (step 822). Then, the error page is returned to the client (step 824) with the process terminating thereafter. If an error occurs while processing the form, the processing method may dump the contents of the user entered fields and other form information to a file. Alternatively, an e-mail may be sent to the system administrator indicating error. The user may then be directed to either an error screen or an confirmation screen. Human interaction on the server side might be necessary to correct the error and process the user input successfully.

Thus, the present invention provides an improved method, apparatus, and computer implemented instructions for handling electronic forms, such as HTML forms. In particular, the mechanism of the present invention allows for a generic or common process for handling all types of forms. The particular manner in which a form is to be handled is specified though placing key word information within the form. In these examples, the key words are located within hidden input fields. In this manner, the mechanism of the present invention reduces the amount of code necessary to implement a form handler process on a data processing system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the illustrated embodiments employ HTML documents, the mechanism of the present invention may be applied to other types of documents. For example, this mechanism may be applied to other markup language documents, such as extensible markup language (XML) documents. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a form, the method comprising:
receiving a markup language form, wherein the markup language form includes first data input by a user and second data in a hidden field identifying how the data is to be processed;
identifying a process to process the first data using the second data to form an identified process; and
processing the first data using the identified process.

2. The method of claim 1, wherein the identified process forwards the data to a selected a location.

3. The method of claim 2, wherein the selected location is at least one of a database, a file, a Web server, a remote computer, and a program.

4. The method of claim 1, wherein the markup language form includes third data in a second hidden field and wherein the third data identifies portions information that are to be present in the first data.

5. The method of claim 1, wherein the markup language form includes third data in a second hidden field and wherein the third data is used to validate the first data.

6. The method of claim 1, wherein the markup language document is a hypertext markup language document.

7. The method of claim 1, wherein the markup language document is an extensible markup language document.

8. The method of claim 1, wherein the first data is a set of text strings.

9. A method in a data processing system for processing a form, the method comprising:
receiving a form, wherein the form includes a set of fields containing a set of data and a hidden field identifying how the data is to be processed; and
identifying a process to process the set of data using the hidden field.

10. The method of claim 9 further comprising:
processing the set of data with the process identified using the hidden field.

11. The method of claim 9, wherein the identified process forwards the data to a selected location.

12. The method of claim 11, wherein the selected location is at least one of a database, a file, a Web server, a remote computer, and a program.

13. The method of claim 9, wherein the form is a markup language document.

14. The method of claim 13, wherein the markup language document is a hypertext markup language document.

15. The method of claim 13, wherein the markup language document is an extensible markup language document.

16. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a markup language form, wherein the markup language form includes first data input by a user and second data in a hidden field identifying how the data is to be processed; identify a process to process the first data using the second data to form an identified process; and process the first data using the identified process.

17. The data processing system of claim 16, wherein the bus system is a single bus.

18. The data processing system of claim 16, wherein the bus system includes a primary bus and a secondary bus.

19. The data processing system of claim 16, wherein the processing unit includes a plurality of processors.

20. The data processing system of claim 16, wherein the communications unit is one of a modem and Ethernet adapter.

21. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a form, wherein the form includes a set of fields containing a set of data and a hidden field identifying how the data is to be processed; and
identify a process to process the set of data using the hidden field.

22. The data processing system of claim 21, wherein the bus system is a single bus.

23. The data processing system of claim 21, wherein the bus system includes a primary bus and a secondary bus.

24. The data processing system of claim 21, wherein the processing unit includes a plurality of processors.

25. The data processing system of claim 21, wherein the communications unit is one of a modem and Ethernet adapter.

26. A data processing system for processing a form, the data processing system comprising:
receiving means for receiving a markup language form, wherein the markup language form includes first data input by a user and second data in a hidden field identifying how the data is to be processed; identifying means for identifying a process to process the first data using the second data to form an identified process; and
processing means for processing the first data using the identified process.

27. The data processing system of claim 26, wherein the identified process forwards the data to a selected a location.

28. The data processing system of claim 27, wherein the selected location is at least one of a database, a file, a Web server, a remote computer, and a program.

29. The data processing system of claim 26, wherein the markup language form includes third data in a second hidden field and wherein the third data identifies portions information that are to be present in the first data.

30. The data processing system of claim 26, wherein the markup language form includes third data in a second hidden field and wherein the third data is used to validate the first data.

31. The data processing system of claim 26, wherein the markup language document is a hypertext markup language document.

32. The data processing system of claim 26, wherein the markup language document is an extensible markup language document.

33. The data processing system of claim 26, wherein the first data is a set of text strings.

34. A data processing system for processing a form, the data processing system comprising:
receiving means for receiving a form, wherein the form includes a set of fields containing a set of data and a hidden field identifying how the data is to be processed; and
identifying means for identifying a process to process the set of data using the hidden field.

35. The data processing system of claim 34 further comprising:
processing means for processing the set of data with the process identified using the hidden field.

36. The data processing system of claim 34, wherein the identified process forwards the data to a selected location.

37. The data processing system of claim 36, wherein the selected location is at least one of a database, a file, a Web server, a remote computer, and a program.

38. The data processing system of claim 34, wherein the form is a markup language document.

39. The data processing system of claim 38, wherein the markup language document is a hypertext markup language document.

40. The data processing system of claim 38, wherein the markup language document is an extensible markup language document.

41. A computer program product in a computer readable medium for processing a form, the computer program product comprising:
first instructions for receiving a markup language form, wherein the markup language form includes first data input by a user and second data in a hidden field identifying how the data is to be processed;
second instructions for identifying a process to process the first data using the second data to form an identified process; and
third instructions for processing the first data using the identified process.

42. The computer program product of claim 41, wherein the identified process forwards the data to a selected a location.

43. The computer program product of claim 42, wherein the selected location is at least one of a database, a file, a Web server, a remote computer, and a program.

44. The computer program product of claim 41, wherein the markup language form includes third data in a second hidden field and wherein the third data identifies portions information that are to be present in the first data.

45. The computer program product of claim 41, wherein the markup language form includes third data in a second hidden field and wherein the third data is used to validate the first data.

46. The computer program product of claim 41, wherein the markup language document is a hypertext markup language document.

47. The computer program product of claim 41, wherein the markup language document is an extensible markup language document.

48. The computer program product of claim 41, wherein the first data is a set of text strings.

49. A computer program product in a computer readable medium for processing a form, the computer program product comprising:
first instructions for receiving a form, wherein the form includes a set of fields containing a set of data and a hidden field identifying how the data is to be processed; and
second instructions for identifying a process to process the set of data using the hidden field.

50. The computer program product of claim 49 further comprising:
third instructions for processing the set of data with the process identified using the hidden field.

51. The computer program product of claim 49, wherein the identified process forwards the data to a selected location.

52. The computer program product of claim 51, wherein the selected location is at least one of a database, a file, a Web server, a remote computer, and a program.

53. The computer program product of claim 49, wherein the form is a markup language document.

54. The computer program product of claim 53, wherein the markup language document is a hypertext markup language document.

55. The computer program product of claim 53, wherein the markup language document is an extensible markup language document.
